(19) United States
(12) Patent Application Publication
(10) Pub. No.: US 2020/0105437 A1
(43) Pub. Date: Apr. 2, 2020

(54) SUPERHYDROPHOBIC CONDUCTIVE COATING AND METHOD FOR PREPARING THE SAME

(71) Applicant: South China University of Technology, Guangzhou (CN)

(72) Inventors: Hongqiang LI, Guangzhou (CN); Xiaojing SU, Guangzhou (CN); Xingrong ZENG, Guangzhou (CN); Xuejun LAI, Guangzhou (CN); Zhonghua CHEN, Guangzhou (CN)

(21) Appl. No.: 16/699,713

(22) Filed: Dec. 1, 2019

Related U.S. Application Data
(63) Continuation-in-part of application No. PCT/CN2018/111932, filed on Oct. 25, 2018.

(30) Foreign Application Priority Data
Nov. 20, 2017 (CN) 201711158028.8

(51) Int. Cl. H01B 1/22; C09D 115/00; C09D 7/62; B05B 3/00; C09D 107/00

(52) U.S. Cl. CPC H01B 1/22; C09D 115/005; C09D 107/00; B05B 3/001; C09D 7/62

(57) ABSTRACT

A coating including a substrate and a plurality of hydrophobic silver particles disposed on the substrate. The contact angle of the coating with water at room temperature is between 152° and 162° and the resistance value of the coating is between 10¹ and 10³Ω.

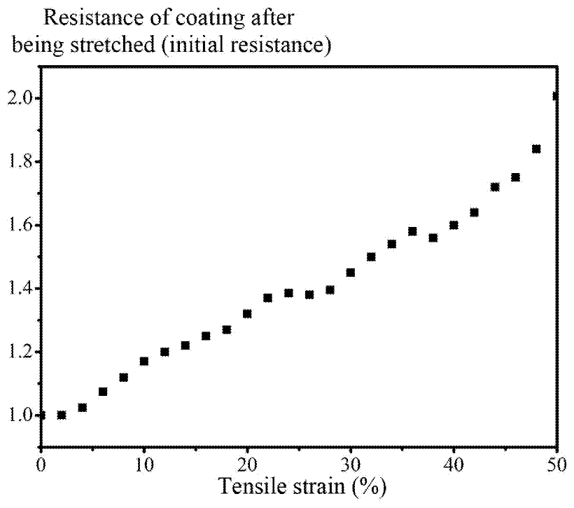

### CROSS-REFERENCE TO RELAYED APPLICATIONS

This application is a continuation-in-part of International Patent Application No. PCT/CN2018/111932 with an international filing date of Oct. 25, 2018, designating the United States, now pending, and further claims foreign priority benefits to Chinese Patent Application No. 201711158028.8 filed Nov. 20, 2017. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to the field of superhydrophobic coatings, and more particularly, to a superhydrophobic conductive coating and a method for preparing the same.

Conventionally, the conductive coatings of the electronic devices are mainly composed of polymer materials, a certain amount of conductive materials such as silver nanowires, nano-silver powders, carbon nanotubes, graphene, and the like, a solvent and auxiliaries. Conventional coatings have poor chemical stability, mechanical durability, and hydrophobicity, and tend to be damaged by external forces.

### SUMMARY

The disclosure provides a coating comprising a substrate comprising rubber and a plurality of hydrophobic silver particles disposed on the substrate; the contact angle of the coating with water at room temperature is between 152° and 162° and the resistance value of the coating is between 10¹ and 10³Ω. In use, after dropping a strong acid or a strong base on the coating for 10-30 min, or stretching and relaxing the coating for 20 cycles, the contact angle remains above 150°, and the coating remains electrically conductive and is super-hydrophobic.

The disclosure also provides a method of preparing the coating, the method comprising:
1) adding 1-3 parts by weight of silver particles to 100 parts by weight of an alcohol solution comprising 0.5-3 wt. % of alkyl mercaptan to yield a mixture; dispersing the mixture by ultrasound, stirring at room temperature, centrifuging, washing, and drying under vacuum, to obtain modified silver particles; and
2) adding 0.5 parts by weight of a thermoplastic elastomer to 20-50 parts by weight of an organic solvent, stirring a resulting mixture at a temperature of 30-60° C. for 3-12 h; adding 1-2 parts by weight of the modified silver particles to the resulting mixture and dispersing for 0.5-2 h by ultrasound to obtain a dispersion; pre-stretching a substrate comprising rubber to 2-3 times of an original length of the substrate with an external force, spraying the dispersion on the substrate; drying the substrate covered by the dispersion, removing the external force so that the substrate restores to its original length, to yield the coating.

The alkyl mercaptan can be a dodecyl mercaptan, tetradecyl mercaptan, cetyl mercaptan, octadecyl mercaptan, or a mixture thereof.

The thermoplastic elastomer can be a styrene-butadiene-styrene triblock copolymer, styrene-isoprene-styrene triblock copolymer, hydrogenated styrene-butadiene-styrene triblock copolymer, hydrogenated styrene-isoprene-styrene triblock copolymer, or a mixture thereof.

The silver particles can have a particle size of 100-300 nm.

The organic solvent can be selected from toluene, xylene, tetrahydrofuran or cyclohexane.

The rubber can be natural rubber, silicone rubber, butyl rubber or nitrile rubber.

In 2), the dispersion can be sprayed on the substrate by a spray gun; a working pressure of the spray gun can be 0.4-0.7 megapascal, a spraying distance from the spray gun to the substrate can be 10-20 cm, a moving speed of the spray gun can be 1-2 cm/s, and a reciprocating motion of the spray gun can be 1-3 cycles.

In 1), the mixture can be dispersed by ultrasound for 5-30 min, stirred for 3-12 h, and centrifuged at 6000-10000 rpm for 10-30 min; the resulting product can be washed with ethanol and dried under vacuum at 30-50° C. for 5-12 h.

In 2), the drying can be performed at 30-50° C. for 10-30 min to completely evaporate the organic solvent.

Advantages of the method of preparing a superhydrophobic conductive coating according to embodiments of the disclosure are summarized as follows:

(1) The coating prepared by the disclosure is hydrophobic, electrically conductive, stretchable, and resistant to acid and base.

(2) With the shrinkage of the rubber substrate, the surface roughness and the number of conductive paths of the superhydrophobic conductive coating increases, so that the coating is hydrophobic and electrically conductive in the stretched state. The electrical conductivity of the coating increases with the increase of the tensile strain.

### BRIEF DESCRIPTION OF THE DRAWINGS

The invention is described hereinbelow with reference to accompanying drawings, in which the sole FIGURE shows the change of resistance of a superhydrophobic conductive coating prepared in Example 1 during stretching.

### DETAILED DESCRIPTION OF THE EMBODIMENTS

To further illustrate, embodiments detailing a superhydrophobic conductive coating and a method for preparing the same are described below. It should be noted that the following embodiments are intended to describe and not to limit the disclosure.

### Example 1

2 g of silver particles in the size range of 100-200 nm were dispersed in 100 g of solution of 1 wt. % cetyl mercaptan in ethanol, and further dispersed by ultrasound for 15 min. After the mixture was stirred at room temperature for 8 h and centrifuged at 8000 rpm for 20 min, ethanol was added to the resulting product and dried under vacuum at 40° C. for 8 h, to obtain the hydrophobic silver particles. 0.35 g of hydrogenated styrene-butadiene-styrene triblock copolymer was added to 17.5 g of toluene and stirred at 40° C. for 5 h. Then 1.05 g of hydrophobic silver particles were added and ultrasonically dispersed for 1 h to prepare a mixed dispersion. A substrate comprising rubber was pre-stretched to 3 times of its original length with an external force, and then the mixed dispersion was sprayed on the substrate with a spray gun (wherein a working pressure of the spray gun is 0.6 megapascal, a spraying distance from the spray gun to the substrate is 15 cm, a moving speed of the spray gun is 1.0 cm/s, and a reciprocating motion of the spray gun is repeated 2 times.). The coating was dried at 30° C. for 15 min to completely evaporate the organic solvent. The external force was then removed to restore the substrate to its original length, and yielding a superhydrophobic conductive coating.

Table 1 lists the contact angle of water and the resistance value of a superhydrophobic conductive coating prepared in Example 1. As can be seen in Table 1, the contact angle is 162.0° and the resistance is 15Ω, which implies an excellent hydrophobicity and an electrical conductivity. The reason for the properties is that the silver particles aggregates on the surface of the coating to form a rough structure as the solvent evaporated from the surface of the coating during the spraying process. The pre-stretched substrate causes the shrinkage of the coating during the recovery process, thereby increasing the surface roughness and forming the conductive paths.

TABLE 1

| Examples | Contact angle | Resistance |
|---|---|---|
| Example 1 | 162.0° | 15 Ω |
| Example 2 | 159.0° | 246 Ω |
| Example 3 | 160.5° | 592 Ω |
| Example 4 | 160.0° | 135 Ω |

Note: the contact angle was measured by a Drop Shape Analyzer-DSA100 (Germany) and the average contact angle for each sample was calculated by choosing five points.

To evaluate the acid-base stability of the superhydrophobic conductive coating prepared in Example 1, a drop of 10 μL of a strong acid (pH=0) and a drop of 10 μL of a strong base (pH=14) were separately dropped on the superhydrophobic conductive coating. After the two drops were allowed to stand for 20 min, the contact angle and resistance were measured, and these results were shown in Table 2. To evaluate the stretchability of the superhydrophobic conductive coating prepared in Example 1, the coating was stretched to 3 times of its original length, and then relaxed and recovered, wherein this process was repeated 20 times. The contact angle and resistance were measured, and these results were also shown in Table 2. As can be seen in Table 2, after a drop of a strong acid (pH=0) and a drop of a strong base (pH=14) were dropped on the coating prepared by the disclosure and allowed to stand for 20 min, the two drops still stood on the surface of the coating with a contact angle of 150°, and the coating left the electrical conductivity unchanged. In addition, the coating was subjected to a stretching and relaxation process for 20 times. Then the contact angle increased to 160.0° and the resistance became 21Ω. The reason behind the changes of the contact angle and resistance was due to the excellent flexibility of the thermoplastic elastomer. The coating can also maintain a micro-nano roughness surface even after being repeatedly stretched and relaxed, and most of the destroyed conductive paths were progressively repaired during the relaxation of the coating. Therefore, the coating still had an excellent hydrophobicity and an electrical conductivity.

TABLE 2

| | Contact water | | | Resistance | | |
|---|---|---|---|---|---|---|
| | Acid | Base | Stretching | Acid | Base | Stretching |
| | (pH = | (pH = | and | (pH = | (pH = | and |
| Samples | 0) | 14) | relaxation | 0) | 14) | relaxation |
| Sample 1 | 154.5° | 155.0° | 160.0° | 16 Ω | 13 Ω | 21 Ω |
| Sample 2 | 152.0° | 151.5° | 157.0° | 245 Ω | 251 Ω | 269 Ω |
| Sample 3 | 155.0° | 154.5° | 158.5° | 602 Ω | 595 Ω | 615 Ω |
| Sample 4 | 150.5° | 151.0° | 156.5° | 140 Ω | 138 Ω | 178 Ω |

Note: the contact angle was measured by a Drop Shape Analyzer-DSA100 (Germany) and the average contact angle for each sample was calculated by choosing five points. The resistance was measured by a micro-ohmmeter (TEGAM1740, USA), and the average resistance for each sample was calculated by choosing three points.

To evaluate the hydrophobicity of the conductive coating prepared in Example 1 in a stretched state, the coating was stretched to 2, 3, 4, 5 and 6 times of its original length and fixed. The surface was subjected to a contact angle test, and these results were shown in Table 3. As can be seen from Table 3, the conductive coating prepared in Example 1 maintained the super-hydrophobicity even after being stretched to different multiples of its original length. The reason for the properties was that the pre-stretched substrate caused the shrinkage of the coating during the recovery process, thereby greatly increasing the surface roughness. Therefore, although the surface morphology of the coating changed during stretching, the micro nano coarse structure was maintained.

TABLE 3

| | Multiples of stretching | | | | |
|---|---|---|---|---|---|
| Samples | 2 | 3 | 4 | 5 | 6 |
| Sample 1 | 160.5° | 159.0° | 156.5° | 157.0° | 153.5° |
| Sample 2 | 158.5° | 155.0° | 156.0° | 153.5° | 152.0° |
| Sample 3 | 158.0° | 160.0° | 157.5° | 156.0° | 154.5° |
| Sample 4 | 157.0° | 159.5° | 157.5° | 154.0° | 153.0° |

Note: the contact angle was measured by a Drop Shape Analyzer-DSA100 (Germany) and the average contact angle for each sample was calculated by choosing five points.

To evaluate the conductivity of the superhydrophobic conductive coating prepared in Example 1 in a stretched state, the resistance during the deformation process of the coating being stretched to 1.5 times of its original length was recorded in real time using a micro-ohmmeter (TEGAM1740, USA). The ratio of the resistance of the coating in the stretched state to the initial resistance of the coating was taken as the ordinate, and the tensile strain of the coating (refers to the ratio of the total change in length of the coating to the original length of the coating×100%) was taken as the abscissa. These results were shown in the sole FIGURE. As can be seen from the sole FIGURE, the resistance of the superhydrophobic conductive coating prepared in Example 1 gradually increased with the tensile strain increasing in the stretching process. The reason for the properties was that silver particles formed a small number of conductive paths in the coating as the solvent evaporated from the surface of the coating during the spraying process. The pre-stretched substrate caused the shrinkage of the coating during the recovery process, further increasing the bulk density of the silver particles on the surface of the coating and forming more conductive paths. But the partial conductive paths formed by the deposition of the silver particles were destroyed during stretching, resulting in a lower electrical conductivity. The resistance of the superhydrophobic conductive coating prepared by the disclosure in response to tensile strain in a stretched state can be applied to sensors and other related fields.

Most superhydrophobic coating materials have only a single function of super-hydrophobicity. The provided superhydrophobic coating comprising a substrate with silver particles and thermoplastic elastomer as main raw materials has excellent super-hydrophobicity, electrical conductivity, acid-base stability and stretchability. The coating maintains hydrophobicity and electrical conductivity in a stretched state. Therefore, the superhydrophobic coating prepared by the disclosure can maintain and utilize super-hydrophobicity and electrical conductivity under harsh environmental conditions and external forces. In the cold weather, the super-hydrophobicity of the coating can prevent the ice from sticking to the surface, and the coating can melt a small amount of ice sticking to the surface due to the heat generated by the electrical conductivity materials. The combination of the two advantages can be well applied to the field of anti-icing. The superhydrophobic coating prepared by the disclosure can also be applied to sensors and its related fields, because there is significant change in resistance in response to tensile strain during stretching.

### Example 2

3 g of silver particles in the size range of 250-300 nm were dispersed in 100 g of solution of 0.5 wt. % tetradecyl mercaptan in ethanol, and further dispersed by ultrasound for 5 min. After the mixture was stirred at room temperature for 3 h and centrifuged at 6000 rpm for 30 min, ethanol was added to the resulting product and dried under vacuum at 30° C. for 12 h, to obtain the hydrophobic silver particles. 0.4 g of styrene-isoprene-styrene triblock copolymer was added to 16 g of xylene and stirred at 30° C. for 12 h. Then 1.2 g of hydrophobic silver particles were added and ultrasonically dispersed for 1 h to prepare a mixed dispersion. A substrate comprising rubber was pre-stretched to 2.5 times of its original length with an external force, and then the mixed dispersion was sprayed on the substrate with a spray gun (wherein a working pressure of the spray gun is 0.7 megapascal, a spraying distance from the spray gun to the substrate is 20 cm, a moving speed of the spray gun is 2.0 cm/s, and a reciprocating motion of the spray gun is repeated 2 times.). The coating was dried at 30° C. for 30 min to completely evaporate the organic solvent. The external force was then removed to restore the substrate to its original length, and yielding a superhydrophobic conductive coating.

Table 1 lists the contact angle of water and the resistance value of a superhydrophobic conductive coating prepared in Example 2. As can be seen in Table 1, the contact angle is 159.0° and the resistance is 246Ω, which exhibit the excellent hydrophobicity and electrical conductivity.

In Example 2, a drop of 10 μL of a strong acid (pH=0) and a drop of 10 μL of a strong base (pH=14) were separately dropped on the superhydrophobic conductive coating. After the two drops were allowed to stand for 20 min, or the coating was repeated 20 times of a stretching and relaxation process, the contact angle and resistance were measured, and these results were shown in Table 2. As can be seen in Table 2, after a drop of a strong acid (pH=0) and a drop of a strong base (pH=14) were dropped on the coating prepared by the disclosure and allowed to stand for 20 min, the two drops still stood on the surface of the coating with a contact angle of above 150°, and the coating left the excellent electrical conductivity and chemical stability unchanged. In addition, the coating was subjected to stretching and relaxation process for 20 times. Then the contact angle of the coating increased to 157.0° and the resistance became 269Ω, illustrating that the coating still had an excellent hydrophobicity and an electrical conductivity.

In Example 2, the superhydrophobic conductive coating was stretched to 2, 3, 4, 5 and 6 times of its original length and fixed. Then the surface was subjected to a contact angle test, and these results were shown in Table 3. As can be seen from Table 3, the superhydrophobic conductive coating prepared in Example 2 maintained the contact angle larger than 150.0° even after being stretched to different multiples of its original length, illustrating that the coating provided a good resistance to tensile strain.

### Example 3

2 g of silver particles in the size range of 200-300 nm were dispersed in 100 g of solution of 2 wt. % of dodecyl mercaptan and cetyl mercaptan (a mass ratio of 1:1) in ethanol, and further dispersed by ultrasound for 20 min. After the mixture was stirred at room temperature for 10 h and centrifuged at 8000 rpm for 15 min, ethanol was added to the resulting product and dried under vacuum at 40° C. for 8 h, to obtain the hydrophobic silver particles. 0.3 g of hydrogenated styrene-isoprene-styrene triblock copolymer was added to 15 g of toluene and stirred at 50° C. for 5 h. Then 1.2 g of hydrophobic silver particles were added and ultrasonically dispersed for 2 h to prepare a mixed dispersion. A substrate comprising rubber was pre-stretched to 3 times of its original length with an external force, and then the mixed dispersion was sprayed on the substrate with a spray gun (wherein a working pressure of the spray gun is 0.5 megapascal, a spraying distance from the spray gun to the substrate is 15 cm, a moving speed of the spray gun is 1.5 cm/s, and a reciprocating motion of the spray gun is repeated 1 time.). The coating was dried at 40° C. for 15 min to completely evaporate the organic solvent. The external force was then removed to restore the substrate to its original length, and yielding a superhydrophobic conductive coating.

Table 1 lists the contact angle of water and the resistance value of a superhydrophobic conductive coating prepared in Example 3. As can be seen in Table 1, the contact angle is 160.0° and the resistance is 592Ω, which exhibit the excellent hydrophobicity and electrical conductivity.

In Example 3, a drop of 10 μl of a strong acid (pH=0) and a drop of 10 μL of a strong base (pH=14) were separately dropped on the superhydrophobic conductive coating. After the two drops were allowed to stand for 20 min, or the coating was repeated 20 times of stretching and relaxation process, the contact angle and resistance were measured, and these results were shown in Table 2. As can be seen in Table 2, after a drop of a strong acid (pH=0) and a drop of a strong base (pH=14) were dropped on the coating prepared by the disclosure and allowed to stand for 20 min, the two drops still stood on the surface of the coating with a contact angle of above 150°, and the coating left the electrical conductivity and excellent chemical stability unchanged. In addition, the coating was subjected to a stretching and relaxation process for 20 times. Then the contact angle of the coating increased to 158.0° and the resistance became 615Ω, illustrating that the coating still had an excellent hydrophobicity and an electrical conductivity.

In Example 3, the superhydrophobic conductive coating was stretched to 2, 3, 4, 5 and 6 times of its original length and fixed. Then the surface was subjected to contact angle test, and these results were shown in Table 3. As can be seen from Table 3, the superhydrophobic conductive coating prepared in Example 2 maintained the contact angle larger than 150.0° even after being stretched to different multiples of its original length, illustrating that the coating provided a good resistance to tensile strain.

### Example 4

1 g of silver particles in the size range of 100-150 nm were dispersed in 100 g of solution of 3 wt. % of octadecyl mercaptan in ethanol, and further dispersed by ultrasound for 30 min. After the mixture was stirred at room temperature for 12 h and centrifuged at 10000 rpm for 10 min, ethanol was added to the resulting product and dried under vacuum at 50° C. for 5 h, to obtain the hydrophobic silver particles. 0.175 g of styrene-butadiene-styrene triblock copolymer was added to 17.5 g of tetrahydrofuran and stirred at 60° C. for 3 h. Then 0.35 g of hydrophobic silver particles were added and ultrasonically dispersed for 0.5 h to prepare a mixed dispersion. A substrate comprising rubber was pre-stretched to 2 times of its original length with an external force, and then the mixed dispersion was sprayed on the substrate with a spray gun (wherein a working pressure of the spray gun is 0.4 megapascal, a spraying distance from the spray gun to the substrate is 10 cm, a moving speed of the spray gun is 1.0 cm/s, and a reciprocating motion of the spray gun is repeated 3 times.). The coating was dried at 50° C. for 10 min to completely evaporate the organic solvent. The external force was removed to restore the substrate to its original length, and yielding a superhydrophobic conductive coating.

Table 1 lists the contact angle of water and the resistance value of a superhydrophobic conductive coating prepared in Example 4. As can be seen in Table 1, the contact angle is 160.0° and the resistance is 135Ω, which exhibit the excellent hydrophobicity and electrical conductivity.

In Example 4, a drop of 10 μL of a strong acid (pH=0) and a drop of 10 μL of a strong base (pH=14) were separately dropped on the superhydrophobic conductive coating. After the two drops were allowed to stand for 20 min, or the coating was repeated 20 times of stretching and relaxation process, the contact angle and resistance were measured, and these results were shown in Table 2. As can be seen in Table 2, after a drop of a strong acid (pH=0) and a drop of a strong base (pH=14) were dropped on the coating prepared by the disclosure and allowed to stand for 20 min, the two drops still stood on the surface of the coating with a contact angle of above 150°, and the coating left the electrical conductivity and excellent chemical stability unchanged. In addition, the coating was subjected to a stretching and relaxation process for 20 times. Then the contact angle of the coating increased to 156.5° and the resistance became 178Ω, illustrating that the coating still had an excellent hydrophobicity and an electrical conductivity.

Table 3 showed the contact angles of the superhydrophobic conductive coating after it was stretched to different times of its original length.

In Example 4, the superhydrophobic conductive coating was stretched to 2, 3, 4, 5 and 6 times of its original length and fixed. Then the surface was subjected to a contact angle test, and these results were shown in Table 3. As can be seen from Table 3, the superhydrophobic conductive coating prepared in Example 4 maintained the contact angle larger than 150.0° even after being stretched to different multiples of its original length, illustrating that the coating provided a good resistance to tensile strain.

It will be obvious to those skilled in the art that changes and modifications may be made, and therefore, the aim in the appended claims is to cover all such changes and modifications.

What is claimed is:

1. A coating, comprising:
1) a substrate, the substrate comprising rubber; and
2) a plurality of hydrophobic silver particles disposed on the substrate;
wherein:
a contact angle of the coating with water is between 152° and 162° and a resistance value of the coating is between 10¹ and 10³Ω.

2. A method of preparation of the coating of claim 1, comprising:
1) adding 1-3 parts by weight of silver particles to 100 parts by weight of an alcohol solution comprising 0.5-3 wt. % of alkyl mercaptan to yield a mixture; dispersing the mixture by ultrasound, stirring at room temperature, centrifuging, washing, and drying under vacuum, to obtain modified silver particles;
2) adding 0.5 parts by weight of a thermoplastic elastomer to 20-50 parts by weight of an organic solvent, stirring a resulting mixture at a temperature of 30-60° C. for 3-12 h; adding 1-2 parts by weight of the modified silver particles to the resulting mixture and dispersing for 0.5-2 h by ultrasound to obtain a dispersion; pre-stretching a substrate comprising rubber to 2-3 times of an original length of the substrate with an external force, spraying the dispersion on the substrate; drying the substrate covered by the dispersion, removing the external force so that the substrate restores to its original length, to yield the coating.

3. The method of claim 2, wherein the alkyl mercaptan is a dodecyl mercaptan, tetradecyl mercaptan, cetyl mercaptan, octadecyl mercaptan, or a mixture thereof.

4. The method of claim 2, wherein the thermoplastic elastomer is a styrene-butadiene-styrene triblock copolymer, styrene-isoprene-styrene triblock copolymer, hydrogenated styrene-butadiene-styrene triblock copolymer, hydrogenated styrene-isoprene-styrene triblock copolymer, or a mixture thereof.

5. The method of claim 2, wherein the silver particles have a particle size of 100-300 nm.

6. The method of claim 2, wherein the organic solvent is selected from toluene, xylene, tetrahydrofuran and cyclohexane.

7. The method of claim 2, wherein the rubber is natural rubber, silicone rubber, butyl rubber, or nitrile rubber.

8. The method of claim 2, wherein in 2), the dispersion is sprayed on the substrate by a spray gun; a working pressure of the spray gun is 0.4-0.7 megapascal, a spraying distance from the spray gun to the substrate is 10-20 cm, a moving speed of the spray gun is 1-2 cm/s, and a reciprocating motion of the spray gun is 1-3 cycles.

9. The method of claim 2, wherein in 1), the mixture is dispersed by ultrasound for 5-30 min, stirred for 3-12 h, and centrifuged at 6000-10000 rpm for 10-30 min; a resulting product is washed with ethanol and dried under vacuum at 30-50° C. for 5-12 h.

10. The method of claim 2, wherein in 2), the drying is performed at 30-50° C. for 10-30 min to evaporate the organic solvent.
